(19) United States
(12) Patent Application Publication
(10) Pub. No.: US 2023/0375671 A1
(43) Pub. Date: Nov. 23, 2023

(54) OPTICAL PROCESSING ASSEMBLY, TOF TRANSMITTING DEVICE, AND TOF DEPTH INFORMATION DETECTOR

(71) Applicant: Shanghai North Ocean Photonics Co., Ltd., Shanghai (CN)

(72) Inventors: Yuhuang Meng, Shanghai (CN); He Huang, Shanghai (CN); Xinye Lou, Shanghai (CN); Xujun Zheng, Shanghai (CN); Tao Lin, Shanghai (CN)

(21) Appl. No.: 18/026,314

(22) PCT Filed: Apr. 30, 2021
(86) PCT No.: PCT/CN2021/091281

§ 371 Date: Mar. 14, 2023

(30) Foreign Application Priority Data
Sep. 14, 2020 (CN) 202010961084.0

(51) Int. Cl. G01S 7/481

(52) U.S. Cl. CPC G01S 7/4814

(57) ABSTRACT

Provided are an optical processing assembly, a ToF transmitting device, and a ToF depth information detector. The optical processing assembly is applied to an illuminating light source. The illuminating light source is configured to transmit detection light to a target field of view. The illuminating light source includes multiple light source units. Each light source unit is lit according to a predetermined timing. The optical processing assembly includes at least one light shaper and a light homogenizer. The at least one optical shaper is configured to perform light beam shaping on the detection light transmitted by each light source unit of the illuminating light source to narrow the divergence angle of the detection light and guide the central propagation direction of each detection light to the preset central angle of a partition

### TECHNICAL FIELD

The present invention relates to the field of three-dimensional sensing technology and, in particular, to an optical processing assembly, a ToF transmitting device, and a ToF depth information detector.

### BACKGROUND

At present, in the mainstream scheme of three-dimensional sensing technology, time of flight (ToF) is widely concerned and applied by industries such as smartphones by virtue of the advantages of a small volume, a low error, direct output of depth data, and strong anti-interference. In terms of technical implementation, there are two types of ToF. One is direct ranging ToF (dToF), that is, a distance is determined by transmitting and receiving light and measuring photon time of flight. The other is mature indirect ranging ToF (iToF) on the market, that is, a distance is determined by converting time of flight by measuring the phase difference between a transmitting waveform and a receiving waveform. The dToF transmits light after a high-frequency modulation. A pulse repetition frequency is very high. A pulse width can reach the magnitude of ns˜ps. High single pulse energy can be obtained in a very short time. A signal-to-noise ratio can be increased while a power supply is kept low in power consumption. A relatively long detection distance can be implemented. The influence of ambient light on ranging accuracy is reduced. The requirements for the sensitivity and the signal-to-noise ratio of a detection device are reduced. At the same time, the characteristics of a high frequency and a narrow pulse width of the dToF make the average energy very small, and the safety of human eyes can be ensured. In addition, the dToF directly determines a distance directly by measuring photon time of flight without conversion, thereby further saving the computing power and responding rapidly.

Since the sensing capability and unique advantages of ToF may also support various functions, there is a wide application prospect in the fields of computers, home appliances, industrial automation, service robots, unmanned aerial vehicles, and Internet of things. In addition to the application of ToF technology on smartphones, the ToF technology begins to play a major role in many fields such as VR/AR gesture interaction, an automobile electronic ADAS, security and surveillance, and new retail, and the application prospect is very wide. At the same time, the information requirement of a smart terminal also increases the requirements for the information acquisition capability of a ToF device. However, the existing ToF device has great disadvantages in terms of energy consumption, a detection range, and a detection depth.

The light energy utilization of the transmitting device of a ToF device in the prior art is relatively low. As a result, the ToF device can acquire less real and effective data, and thus the ToF device has problems such as low data accuracy and a small detection range.

### SUMMARY

A main advantage of the present invention is to provide an optical processing assembly, a ToF transmitting device, and a ToF depth information detector. The ToF transmitting device divides a target area into multiple partitions and periodically detects the depth information of each partition, thereby improving the detection performance of the ToF transmitting device.

Another advantage of the present invention is to provide an optical processing assembly, a ToF transmitting device, and a ToF depth information detector. In an embodiment of the present invention, the ToF transmitting device detects the depth information of each partition in a partition detection manner, thereby expanding the detection range and/or the detection depth of the ToF transmitting device.

Another advantage of the present invention is to provide an optical processing assembly, a ToF transmitting device, and a ToF depth information detector. In an embodiment of the present invention, the light homogenizing angle of a light homogenizer in the optical processing assembly can adjust the lighting range of detection light to form a continuous and uniform lighting area in a target field of view, thereby improving the detection accuracy and detection quality of the ToF depth information detector.

Another advantage of the present invention is to provide an optical processing assembly, a ToF transmitting device, and a ToF depth information detector. In an embodiment of the present invention, the ToF transmitting device can implement relative long distance detection with relative low power consumption.

Another advantage of the present invention is to provide an optical processing assembly, a ToF transmitting device, and a ToF depth information detector. In an embodiment of the present invention, the optical processing assembly, the ToF transmitting device, and the ToF depth information detector may be applied in smartphones to satisfy the requirements of increasingly diverse applications for rear and front three-dimensional depth information detection.

Another advantage of the present invention is to provide an optical processing assembly, a ToF transmitting device, and a ToF depth information detector. In an embodiment of the present invention, the optical processing assembly, the ToF transmitting device, and the ToF depth information detector may be applied in VR/AR to satisfy the ever-increasing requirements for motion capture and identification, environmental awareness, and modeling.

Another advantage of the present invention is to provide an optical processing assembly, a ToF transmitting device, and a ToF depth information detector. In an embodiment of the present invention, the sensing capabilities and unique advantages of the optical processing assembly, the ToF transmitting device, and the ToF depth information detector support various functions, including gesture sensing or proximity detection for various innovative user interfaces, and have a wide application prospect in the fields of computers, home appliances, industrial automation, service robots, unmanned aerial vehicles, and Internet of things.

Another advantage of the present invention is to provide an optical processing assembly, a ToF transmitting device, and a ToF depth information detector. In an embodiment of the present invention, the ToF transmitting device includes a light shaper. The light shaper narrows the divergence angle of each partition of an illuminating light source in a specified direction and guides the central propagation direction of the light beam of a partition to the preset central angle of a partition, thereby improving light energy utilization.

Another advantage of the present invention is to provide an optical processing assembly, a ToF transmitting device, and a ToF depth information detector. In an embodiment of the present invention, the light shaper and the light homogenizer in the ToF transmitting device are an integrated structure, thereby reducing the volume of the ToF transmitting device and reducing the difficulty of assembly and adjustment.

Other advantages and features of the present invention are fully apparent from the detailed description below and may be implemented by the combination of means and devices particularly pointed out in the appended claims.

According to an aspect of the present invention, an optical processing assembly of the present invention capable of implementing the preceding objects and other objects and advantages is applied to an illuminating light source. The illuminating light source is configured to transmit detection light to the target field of view. The illuminating light source includes multiple light source units. Each light source unit is lit according to a predetermined timing. The optical processing assembly includes at least one light shaper and a light homogenizer.

The at least one optical shaper is configured to perform light beam shaping on the detection light transmitted by each light source unit of the illuminating light source to narrow the divergence angle of the detection light and guide the central propagation direction of each detection light to the preset central angle of a partition.

The light homogenizer is configured to homogenize the detection light transmitted by each light source unit and project the detection light outward to form a target field of view interval. The light homogenizing angle of the light homogenizer is used for adjusting the lighting range of the detection light to form a continuous and uniform lighting area in the target field of view.

According to an embodiment of the present invention, the light homogenizer includes multiple light homogenizing units. Each light homogenizing unit is configured to homogenize the detection light transmitted by a corresponding light source unit.

According to an embodiment of the present invention, the light homogenizing angle of a light homogenizing unit of the light homogenizer is equal to the difference between a first angle and a second angle. The first angle is the minimum lighting angle required for the detection light transmitted by adjacent light source units to generate no gap between adjacent lighting areas formed after the detection light is processed by the optical processing assembly. The second angle is a lighting angle formed after the detection light transmitted by a light source unit is only shaped by the light shaper.

According to an embodiment of the present invention, the light homogenizing angle of the light homogenizing unit of the light homogenizer satisfies the following relationship:

$${θ}_{H} \geq 2 * \{ arctan [ \frac{\vert {N}_{x} - 2 \times i \vert + 2}{{N}_{x}} \times tan ( {FOV}_{H} / 2 ) ] - arctan [ \frac{\vert {N}_{x} - 2 \times i \vert + 2 - x / ( W + x )}{{N}_{x}} \times tan ( {FOV}_{H} / 2 ) ] \}$$

$${θ}_{V} \geq 2 * \{ arctan [ \frac{\vert {N}_{y} - 2 \times j \vert + 2}{{N}_{y}} \times tan ( {FOV}_{V} / 2 ) ] - arctan [ \frac{\vert {N}_{y} - 2 \times j \vert + 2 - y / ( H + y )}{{N}_{y}} \times tan ( {FOV}_{V} / 2 ) ] \}$$

θ_{H} denotes a light homogenizing angle of each light homogenizing unit of the light homogenizer in a first direction, and θ_{V} denotes a light homogenizing angle of each light homogenizing unit of the light homogenizer in a second direction. Nₓ denotes the number of light source units of the illuminating light source in the first direction, and N_{y} denotes the number of light source units of the illuminating light source in the second direction. W denotes the size of a light source unit of the illuminating light source in the first direction, and H denotes the size of the light source unit of the illuminating light source in the second direction. x denotes the spacing distance between adjacent light source units in the first direction, and y denotes the spacing distance between adjacent light source units in the second direction. FOV_{H} denotes a total field of view angle in the first direction, and FOV_{V} denotes a total field of view angle in the second direction. i denotes the partition number of the light source unit in the first direction, and j denotes the partition number of the light source unit in the second direction.

According to an embodiment of the present invention, the focal length of the light shaper satisfies the following relationship:

$${f}_{x} = \frac{( W + x ) \times {N}_{x}}{2 \times tan ( {FOV}_{H} / 2 )}$$

$${f}_{y} = \frac{( H + y ) \times {N}_{y}}{2 \times tan ( {FOV}_{V} / 2 )}$$

Nₓ denotes the number of light source units of the illuminating light source in the first direction, and N_{y} denotes the number of light source units of the illuminating light source in the second direction. W denotes the size of the light source unit of the illuminating light source in the first direction, and H denotes the size of the light source unit of the illuminating light source in the second direction. x denotes the spacing distance between adjacent light source units in the first direction, and y denotes the spacing distance between adjacent light source units in the second direction. FOV_{H} denotes the total field of view angle in the first direction, and FOV_{V} denotes the total field of view angle in the second direction.

According to an embodiment of the present invention, the homogenizer includes a whole sheet of light homogenizing sheet and is configured to homogenize all detection light transmitted by the illuminating light source.

According to an embodiment of the present invention, the light shaper is adapted to be disposed between the light homogenizer and the illuminating light source and configured to project the detection light transmitted by the illuminating light source to the light homogenizer after the detection light is pre-shaped by the light shaper.

According to an embodiment of the present invention, the light homogenizer is adapted to be disposed between the illuminating light source and the light shaper and configured to project the detection light transmitted by the illuminating light source to the light shaper after the detection light is homogenized by the light homogenizer.

According to an embodiment of the present invention, the light shaper and the light homogenizer are two separate components or form an integral component.

According to an embodiment of the present invention, the light shaper has a light incident surface and a light emitting surface. Each light homogenizing unit of the light homogenizer is disposed on the light incident surface of the light shaper.

According to an embodiment of the present invention, the light homogenizing units of the light homogenizer are disposed on the light incident surface of the light shaper by imprinting.

According to an embodiment of the present invention, the light homogenizer is a light homogenizing sheet based on light refraction.

According to another aspect of the present disclosure, the present invention also provides a ToF transmitting device configured to transmit detection light to a target field of view. The device includes an illuminating light source and an optical processing assembly.

The illuminating light source is configured to periodically transmit the detection light in a partition transmitting manner in a certain order to light up the target field of view.

The optical processing assembly includes at least one light shaper and a light homogenizer.

The at least one light shaper is disposed in the lighting direction of the illuminating light source and configured to perform light beam shaping on the detection light transmitted by the illuminating light source to narrow the divergence angle of the detection light and guide the central propagation direction of the detection light to the preset central angle of a partition.

The light homogenizer is disposed in the lighting direction of the illuminating light source and configured to homogenize the detection light transmitted by the illuminating light source and project the detection light outward to form a target field of view interval. The light homogenizing angle of the light homogenizer is used for adjusting the lighting range of the detection light to form the continuous and uniform lighting area in the target field of view.

According to an embodiment of the present invention, the illuminating light source includes multiple light source units. Each light source unit may be lit according to the predetermined timing so that the detection light transmitted by the light source units is projected outward by the light homogenizer to form the target field of view.

According to an embodiment of the present invention, the light homogenizer includes multiple light homogenizing units. Each light homogenizing unit is configured to correspondingly homogenize the detection light transmitted by a light source unit. Alternatively, the homogenizer includes a whole sheet of light homogenizing sheet and is configured to homogenize all detection light transmitted by the illuminating light source.

According to another aspect of the present disclosure, the present invention also provides a ToF depth information detector. The ToF depth information detector includes a ToF transmitting device.

The ToF transmitting device is configured to transmit detection light to a target field of view. The ToF transmitting device includes an illuminating light source and an optical processing assembly.

The illuminating light source is configured to periodically transmit the detection light in a partition transmitting manner in a certain order to light up the target field of view.

The optical processing assembly includes at least one light shaper, a light homogenizer, and a receiving device.

The at least one light shaper is disposed in the lighting direction of the illuminating light source and configured to perform light beam shaping on the detection light transmitted by the illuminating light source to narrow the divergence angle of the detection light and guide the central propagation direction of the detection light to the preset central angle of a partition.

The light homogenizer is disposed in the lighting direction of the illuminating light source and configured to homogenize the detection light transmitted by the illuminating light source and project the detection light outward to form a target field of view interval. The light homogenizing angle of the light homogenizer is used for adjusting the lighting range of the detection light to form the continuous and uniform lighting area in the target field of view.

The receiving device receives the reflected light of the detection light in the target field of view to acquire the depth information of the target field of view.

Further object and advantages of the present invention are fully apparent from an understanding of the description and drawings below.

These and other objects, features, and advantages of the present invention are fully apparent from the detailed description, drawings and claims below.

### BRIEF DESCRIPTION OF DRAWINGS

FIG. 1 is a diagram of a ToF depth information detector according to a preferred embodiment of the present invention.

FIGS. 2A and 2B are diagrams of a ToF transmitting device of the ToF depth information detector according to the preceding preferred embodiment of the present invention.

FIG. 2C is a diagram of another optional embodiment of the ToF transmitting device according to the preceding preferred embodiment of the present invention.

FIG. 3A is a diagram of partitions of an illuminating light source of the ToF transmitting device according to the preceding preferred embodiment of the present invention.

FIG. 3B is a diagram illustrating the structure of a light homogenizer of the ToF transmitting device according to the preceding preferred embodiment of the present invention.

FIGS. 4A to 4G are optical path diagrams of partitions of the ToF transmitting device and an optical path diagram of one period according to the preceding preferred embodiment of the present invention.

FIGS. 5A and 5B are diagrams of the lighting area of the ToF transmitting device according to the preceding preferred embodiment of the present invention.

FIGS. 6A and 6B are diagrams of the light homogenizing angle of a light homogenizing unit in the light homogenizer in a first direction and the light homogenizing angle of the light homogenizing unit in the light homogenizer in a second direction respectively according to the preceding preferred embodiment of the present invention.

FIGS. 7A and 7B are distribution diagrams of light source units in the illuminating light source and corresponding lighting areas respectively according to the preceding preferred embodiment of the present invention.

FIG. 8 is a diagram of another optional embodiment of the ToF transmitting device according to the preceding preferred embodiment of the present invention.

FIG. 9 is a diagram of another optional embodiment of an optical processing assembly of the ToF transmitting device according to the preceding preferred embodiment of the present invention.

FIG. 10 is a diagram of another optional embodiment of an optical processing assembly of the ToF transmitting device according to the preceding preferred embodiment of the present invention

### DETAILED DESCRIPTION

The present invention is disclosed by the description below to be implemented by those skilled in the art. The preferred embodiments in the description below are used only by way of example, and those skilled in the art may conceive of other apparent variations. The basic principles, as defined in the description below, of the present invention may be applied to other embodiments, modifications, improvements, equivalents, and other technical solutions without departing from the spirit and scope of the present invention.

It is to be understood by those skilled in the art that in the disclosure of the present invention, orientational or positional relationships indicated by terms “longitudinal”, “transverse”, “above”, “below”, “front”, “back”, “left”, “right”, “vertical”, “horizontal”, “top”, “bottom”, “inside”, “outside” and the like are based on the orientational or positional relationships illustrated in the drawings, which are merely for facilitating and simplifying the description of the present invention. These relationships do not indicate or imply that a device or element referred to have a specific orientation and is constructed and operated in a specific orientation, and thus it is not to be construed as limiting the present invention.

It may be understood that the term “one” should be regarded as “at least one” or “one or more”. That is, the number of an element may be one in an embodiment and the number of the element may be multiple in another embodiment. The term “one” should not be considered to limit the number.

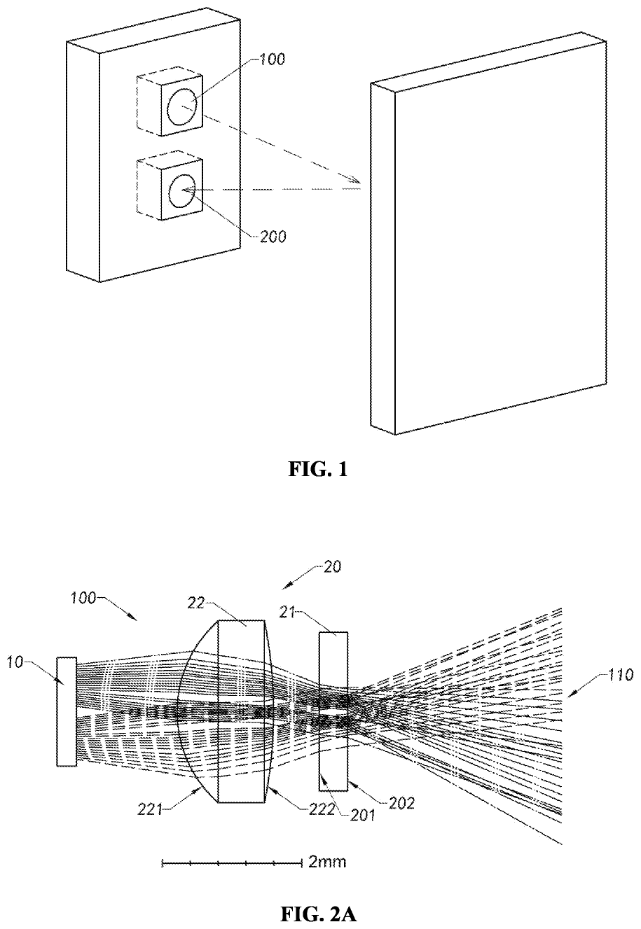

Referring to FIGS. 1 to 5B of the drawings of the description of the present invention, a ToF depth information detector according to a preferred embodiment of the present invention is illustrated in the description below. The ToF depth information detector includes a ToF transmitting device 100 and a receiving device 200. The ToF transmitting device 100 is communicatively connected to the receiving device 200. The ToF transmitting device 100 is configured to transmit detection light to a target field of view 110. The reflected light of the detected object in the target field of view 110 is received by the receiving device 200 to obtain the depth detection information of the detected object.

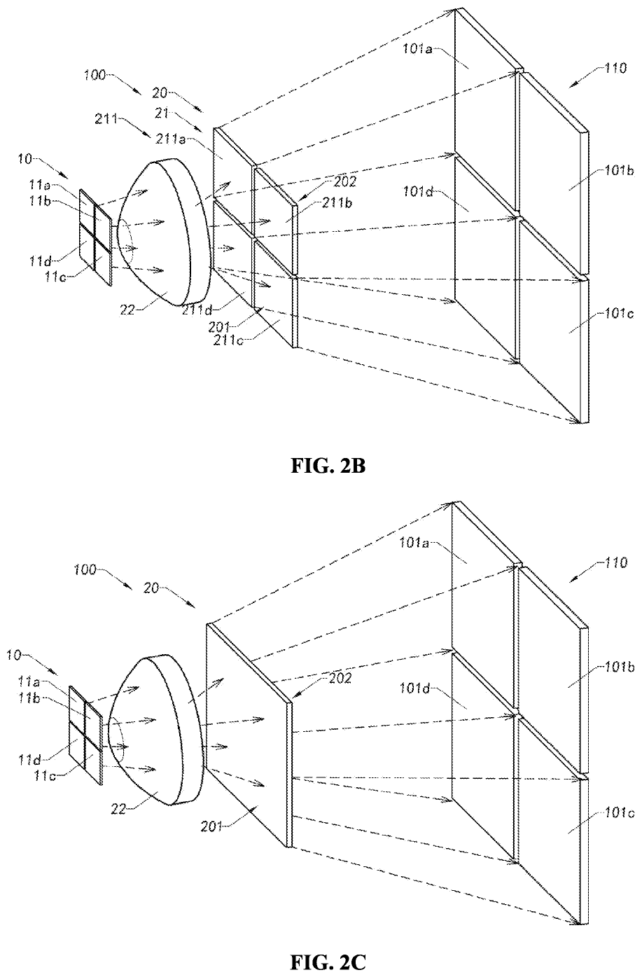

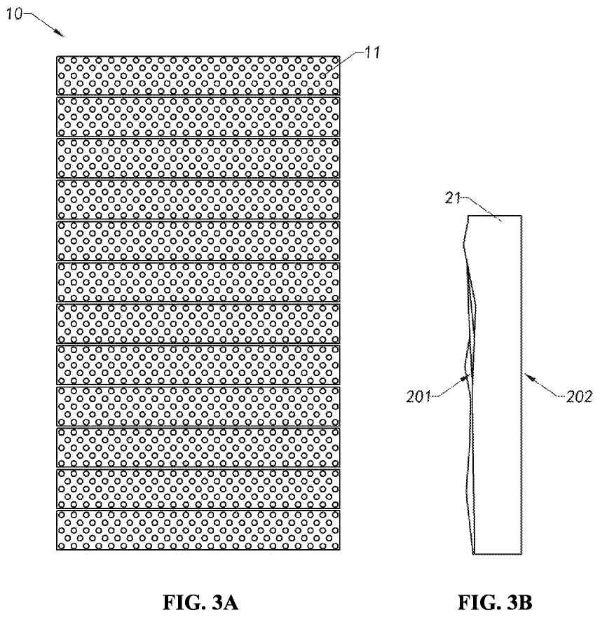

Referring to FIGS. 2A to 5B of the drawings of the description of the present invention, the ToF transmitting device 100 is applied to a ToF depth information detector. The ToF transmitting device 100 transmits detection light to a target field of view 110 in a partition transmitting manner. The ToF transmitting device 100 divides the target field of view 110 into specific partitions for arrangement and lights each partition according to a predetermined timing. In other words, the ToF depth information detector detects different partitions of the target field of view 110 at different times and completes the detection of the target field of view in one period.

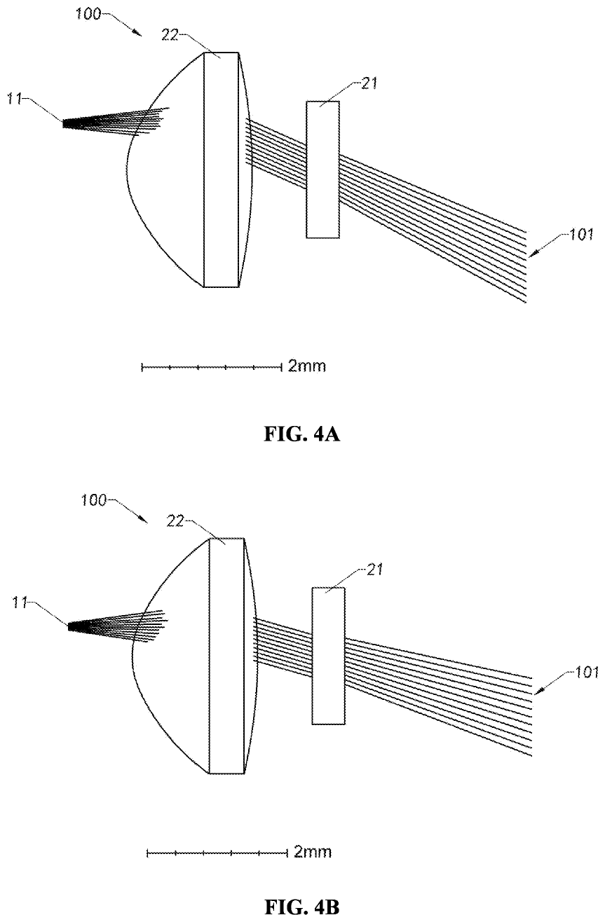

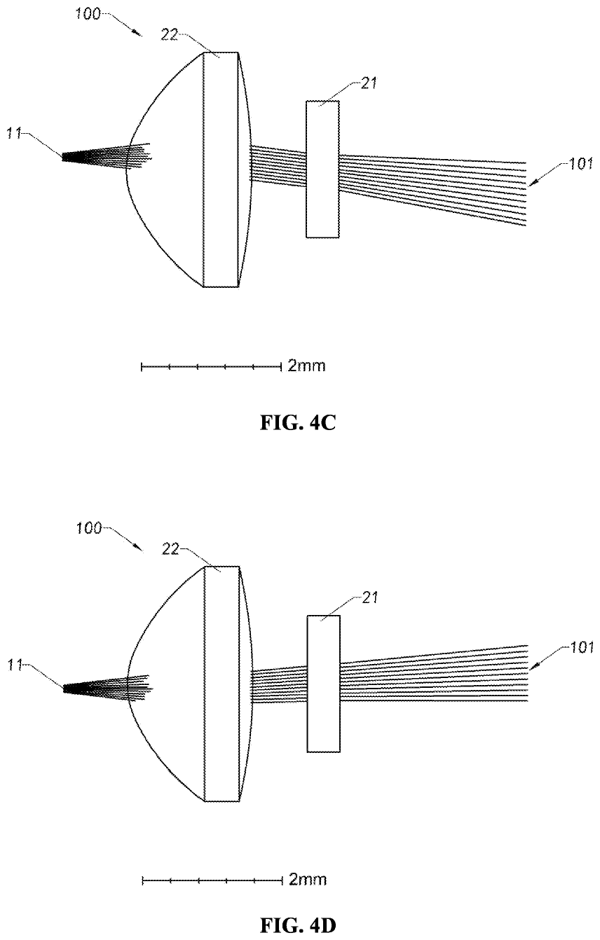

As shown in FIGS. 2A and 3B, the ToF transmitting device 100 includes an illuminating light source 10 and an optical processing assembly 20. The illuminating light source 10 is configured to transmit the detection light in the predetermined timing in a partition transmitting manner. The optical processing assembly 20 is disposed in the lighting direction of the illuminating light source 10. The detection light transmitted by the illuminating light source 10 is projected outward by the optical processing assembly 20 to form the target field of view 110. The optical processing assembly 20 modulates the detection light transmitted outward by the illuminating light source 10, and a uniform light field is formed in a desired field-of-view angle range to light the target field of view 110.

Preferably, in the preferred embodiment of the present invention, the illuminating light source 10 of the ToF transmitting device 100 is implemented as a partitioned vertical-cavity surface-emitting laser (VCSEL) source. The illuminating light source 10 includes multiple light source units 11. Each light source unit 11 may be lit according to the predetermined timing. The detection light transmitted by a single light source unit 11 is projected outward by the optical processing assembly 20 to form a target field of view interval 101. In one period, each light source unit 11 of the illuminating light source 10 transmits detection light according to the predetermined timing, and the detection light forms the target field of view interval 101 through the optical processing assembly 20, and target field of view intervals 101 are combined to form the target field of view 110.

It is to be understood by those skilled in the art that when the illuminating light source 10 transmits the detection light, one light source unit 11 of the illuminating light source 10 is lit, while the other light source units 11 of the illuminating light source 10 are not lit. In one detection period, only one or more of the light source units 11 of the illuminating light source 10 are lit in each lighting operation. For example, only one light source unit 11 is lit each time, so that energy consumption during the detection of the illuminating light source 10 can be greatly reduced. Each light source unit 11 of the illuminating light source 10 forms the target field of view interval 101 through the optical processing assembly 20, and target field of view intervals 101 are combined to form the target field of view 110. In this manner, the ToF transmitting device 100 can increase the detection distance and expand the detection field of view range of the ToF transmitting device 100 with low power consumption.

It is to be understood that in the preferred embodiment of the present invention, the light source units 11 of the illuminating light source 10 are integrated into a light source chip. Optionally, in other optional embodiments of the present invention, each light source unit 11 is formed in a partition manner by the illuminating light source 10. The illuminating light source 10 has multiple partition manners, which may be uniform partition, that is, each light source unit 11 formed by the partitioning has the same shape and size; or may be non-uniform partition, that is, each light source unit 11 formed by the partitioning has different shape and size.

For example, the illuminating light source 10 is uniformly partitioned into 2×2, 4×4, 2×6, or 1×12 light source units 11. Each light source unit 11 corresponds to a different area of the optical processing assembly 20. An embodiment of the illuminating light source 10 is shown in FIG. 3A.

The optical processing assembly 20 also includes a light homogenizer 21 and at least one light shaper 22. The light homogenizer 21 is disposed in the lighting direction of the illuminating light source 10. The light homogenizer 21 is configured to homogenize the detection light transmitted by the illuminating light source 10 in a preset angle range and project the detection light outward to form a target field of view. The light shaper 22 of the optical processing assembly 20 is located in the light incident direction of the light homogenizer 21. The light shaper 22 is configured to narrow the divergence angle of the detection light transmitted by each partition of the illuminating light source 10. It is to be understood that in the preferred embodiment of the present invention, the light shaper 22 is implemented as a pre-shaping element. The light shaper 22 is disposed in the light incident direction of the light homogenizer 21, whereby the light shaper 22 narrows the divergence angle of each partition of the illuminating light source 10 in the vertical direction and guides the central propagation direction of the light beam of each partition of the light source 10 to the preset central angle of the partition.

Corresponding to the partition of the illuminating light source 10, the light homogenizer 21 also has a corresponding partition structure. Each partition structure of the light homogenizer 21 has a different design and microstructure. The partition structure of the light homogenizer 21 modulates the light beam transmitted by each light source unit 11 of the illuminating light source 10 and homogenizes the light beam transmitted by the light source unit 11 in a specified range.

The light homogenizer 21 includes multiple light homogenizing units 211. Each light homogenizing unit 211 corresponds to the light source unit 11 of the illuminating light source 10. A light homogenizing unit 211 modulates the detection light transmitted by at least one light source unit 11 of the illuminating light source 10. Each light homogenizing unit 211 homogenizes the detection light transmitted by the light source unit 11 in a specific range. Preferably, in the preferred embodiment of the present invention, the number of light source units 11 of the illuminating light source 10 is the same as the number of light homogenizing units 211 of the light homogenizer 21. Each light homogenizing unit 211 is in one-to-one correspondence with a light source unit 11. It is to be understood by those skilled in the art that the number of partitions of the light homogenizing units 211 of the light homogenizer 21 is different from the number of light source units 11. For example, two light source units 11 correspond to the same light homogenizing unit 211.

As shown in FIGS. 2A and 2B, the illuminating light source 10 is uniformly partitioned into 2×2 light source units 11 (11a, 11b, 11c, and 11d). The light homogenizer 21 is uniformly partitioned into 2×2 light homogenizing units 211 (211a, 211b, 211c, and 211d). Each light source unit 11 of the illuminating light source 10 is periodically lit at a certain timing. The detection light transmitted by the light source unit 11a is projected to the light homogenizing unit 211c through the light shaper 22, and the light source unit 11a correspondingly forms a target field of view interval 101c. The detection light transmitted by the light source unit 11b is projected to the light homogenizing unit 211d through the light shaper 22, and the light source unit 11b correspondingly forms a target field of view interval 101d. The detection light transmitted by the light source unit 11c is projected to the light homogenizing unit 211a through the light shaper 22, and the light source unit 11c correspondingly forms a target field of view interval 101a. The detection light transmitted by the light source unit 11d is projected to the light homogenizing unit 211b through the light shaper 22, and the light source unit 11d correspondingly forms a target field of view interval 101b. It is to be noted that the correspondence between a light source unit 11, a light homogenizing unit 211, and the target field of view interval 101 is only an example. This is not limited in this embodiment.

Referring to FIG. 2C of the drawings of the description of the present invention, according to another aspect of the present invention, another optional embodiment of the light homogenizer 21 of the ToF transmitting device 100 is shown. The light homogenizer 21 of the ToF transmitting device 100 differs from the preceding partition structure in that the light homogenizer 21 is an integrated structure without partitions. It is to be understood that the structure of the non-partitioned light homogenizer 21 is simpler than the structure of the partitioned light homogenizer 21. The light homogenizer 21 has the same function as the partitioned light homogenizer 21. In the preferred embodiment of the present invention, when the light homogenizer 21 is mounted with the light source units 11 of the illuminating light source 10, it is not necessary to mount the light homogenizer 21 in alignment with the illuminating light source 10, thereby simplifying the mounting process of the light homogenizer 21 and the illuminating light source 10. The light homogenizer 21 has a light homogenizer incident surface 201 and a light homogenizer emitting surface 202. The detection light transmitted by a light source unit 11 is incident to each light homogenizing unit 211 of the light homogenizer 21 through the light homogenizer incident surface 201. The modulated detection light is emitted outward at a specific angle through the light homogenizer emitting surface 202.

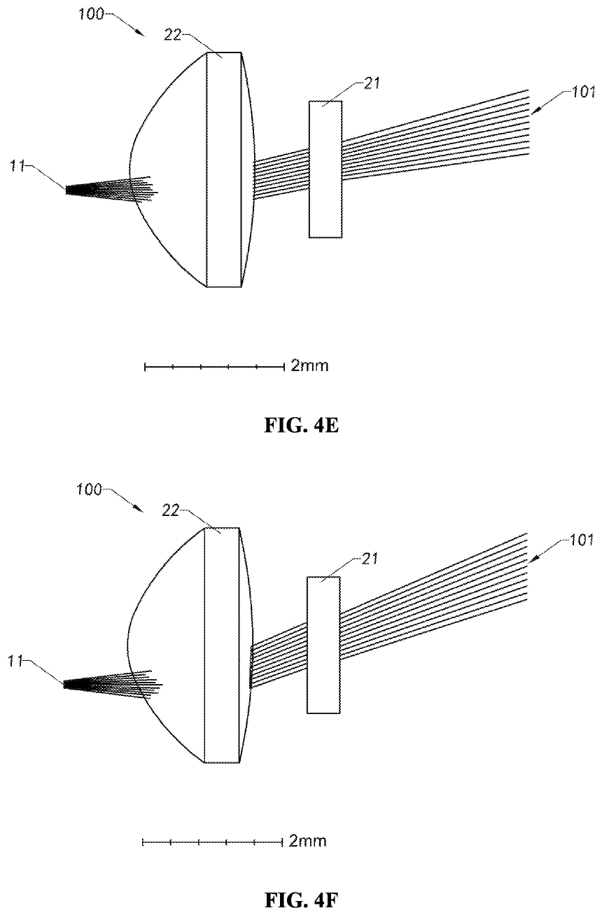

As shown in FIGS. 4A and 4G, the light source unit 11 of each partition of the illuminating light source 10 is lit in a specific order in one period. The detection light transmitted by the light source unit 11 is projected to the light homogenizer 21 through the light shaper 22. The light homogenizing unit 211 of each partition of the light homogenizer 21 modulates the detection light transmitted by the light source unit 11 of the corresponding partition, thereby completing the detection lighting of the entire target field of view 110. For example, the total FOV of the ToF transmitting device 100 is (30°˜150°)×(30°˜150°). Particularly, in the preferred embodiment of the present invention, the FOV of the ToF transmitting device 100 is 72°×60°.

It is to be noted that the embodiment of the optical processing assembly 20 is not limited, for example, but not limited to, the embodiment in which the light homogenizer 21 of the optical processing assembly 20 may use a diffraction-based method to modulate detection light, that is, the light homogenizer 21 of the optical processing assembly 20 may be a DOE light homogenizing sheet.

Of course, a conventional light homogenizing sheet based on a scattering principle can also be applied to the modulation of the detection light. The light homogenizing sheet mainly adds chemical particles to the light homogenizing film substrate and uses the chemical particles as scattering particles, so that when light rays pass through a light homogenizing layer, the light rays continuously refract, reflect, and scatter in two media with different refractive indexes. In this manner, the effect of optical homogenization is generated. However, for this kind of light homogenizing sheet based on the scattering principle, there is inevitably the absorption of light by scattering particles. As a result, the light energy utilization is low, and the light field is uncontrollable. Furthermore, it is difficult to flexibly form the specified light field distribution according to specified requirements, and it is also prone to inhomogeneity of the light field and the existence of “hot spots”.

Preferably, according to the preceding embodiment of the present invention, as shown in FIG. 2B, the light homogenizer 21 of the optical processing assembly 20 may be implemented as a light homogenizing sheet based on the principle of light refraction. The light homogenizer 21 may be divided into multiple light homogenizing units 211. The number of light homogenizing units 211 of the light homogenizer 21 is the same as the number of light source units 11 of the illuminating light source 10. One light homogenizing unit 211 corresponds to one light source unit 11. It is to be understood that the light homogenizing sheet based on the principle of light refraction may homogenize light based on a microlens array, that is, light is refracted in different directions through a micro-concave-convex structure on the surface of the microlens array when the light passes through the structure so that the light is homogenized. Since this type of light homogenization is entirely based on the refraction of light by the microstructure of the surface of the microlens array, there is no absorption of light by the scattering particles in a scattering-type homogenizing sheet. Thus, the light energy utilization is high, and a light homogenizing angle, the space of a light field, and the energy distribution of the light field may be adjusted by changing the shape and the arrangement of the microlens array. In this manner, the flexibility is great.

More preferably, in the preferred embodiment of the present invention, the light shaper 22 is disposed between the illuminating light source 10 and the light homogenizer 21 in the light transmitting direction of the illuminating light source 10, whereby the light shaper 22 performs light field pre-shaping on the detection light projected by the illuminating light source 10 to the light homogenizer 21. The light homogenizer 21 modulates the detection light transmitted outward by the illuminating light source 10, and a uniform light field is formed in a desired field-of-view angle range to light the target field of view 110.

It is to be understood that in the preferred embodiment of the present invention, the light shaper 22 is implemented as a pre-shaping element. The light shaper 22 is disposed in the light incident direction of the light homogenizer 21, whereby the light shaper 22 narrows the divergence angle of the detection light of each partition of the illuminating light source 10 in the vertical direction and guides the central propagation direction of the light beam of each partition of the illuminating light source 10 to the preset central angle of the partition.

For example, as shown in FIG. 3A, the illuminating light source 10 is partitioned into 12 light source units 11 in the vertical direction. Each light source unit 11 is periodically lit in a specific order. The specific parameters of the illuminating light source 10 are shown in the table below.

| | |
|---|---|
| Partition | 1 × 12 |
| Wavelength | 940 nm + 6 nm |
| Single point light | 15 um |
| emission aperture | |
| Single point size | 30 um |
| Light shape | donut |
| Divergence angle | 25 degrees |
| Partition size | 2 × 0.08 mm |
| Total size | 2 × 1.5 mm |

The light homogenizer 21 includes multiple light homogenizing units 211. Each light homogenizing unit 211 corresponds to the light source unit 11 of the illuminating light source 10. A light homogenizing unit 211 modulates the detection light transmitted by at least one light source unit 11 of the illuminating light source 10. Each light homogenizing unit 211 homogenizes the detection light transmitted by the light source unit 11 in a specific range. The light homogenizing unit 211 of each partition of the light homogenizer 21 is configured to homogenize the detection light shaped by the light shaper 22, so that the detection light transmitted by the illuminating light source 10 can uniformly light each target field of view interval 101 to ensure the light energy utilization of the ToF depth information detector.

As shown in FIG. 3B, the light homogenizer 21 has a light homogenizer incident surface 201 and a light homogenizer emitting surface 202. The detection light transmitted by a light source unit 11 is incident to each light homogenizing unit 211 of the light homogenizer 21 through the light homogenizer incident surface 201. The modulated detection light is emitted outward through the light homogenizer emitting surface 202.

Preferably, in the preferred embodiment of the present invention, the light homogenizer 21 adopts a regular or random microlens array. When the light homogenizer 21 adopts a random microlens array, the microens structure of each light homogenizing unit 211 is different. In the preferred embodiment of the present invention, the surface type of the microlens of each homogenizing unit 211 of the light homogenizer 21 may be expressed as:

$$z = \frac{{cr}^{2}}{1 + \sqrt{1 - ( 1 + k ) {c}^{2} {r}^{2}}} + {\sum }_{i = 1}^{N} {A}_{i} {E}_{i} ( x , y ) \frac{{cr}^{2}}{1 + \sqrt{1 - ( 1 + k ) {c}^{2} {r}^{2}}}$$

denotes a basic aspheric term. c denotes curvature. k denotes a cone coefficient. Σᵢ₌₁^{N}AᵢEᵢ(x, y) is an extension polynomial. N denotes the number of polynomials. Aᵢ denotes the coefficient of the i-th extended polynomial term.

The polynomial Eᵢ (x, y) is the power series of x and y. The first item is x, then y, then x×x, x×y, y×y, . . . , and so on. In the preferred embodiment of the present invention, the light homogenizer emitting surface 202 of the light homogenizer 21 is a plane.

It is to be understood by those skilled in the art that each light homogenizing unit 211 of the light homogenizer 21 adopts a different surface type parameter. The detection light transmitted by each light source unit 11 of the illuminating light source 10 is modulated by each light homogenizing unit 211 of a different partition, and the detection light transmitted by the corresponding light source unit 11 uniformly lights the corresponding target field of view interval 101.

The light shaper 22 shapes the detection light transmitted by each light source unit 11 of the illuminating light source 10. The light shaper deflects the detection light in a specific direction and compresses the divergence angle of the detection light and projects the shaped detection light to each light homogenizing unit 211 of the light homogenizer 21 corresponding to each light source unit 11. In this manner, each homogenizing unit 211 projects outward the detection light to form the target field of view 110. The light shaper 22 is configured to narrow the divergence angle of the detection light transmitted by the light source unit 11 of each partition of the illuminating light source 10 in the vertical direction and guide the central propagation direction of the light beam of the light source unit 11 of the partition to a preset central angle of the partition.

It is to be noted that in the preferred embodiment of the present invention, the light shaper 22 may be, but is not limited to, a spherical lens, an aspheric lens, a Fresnel lens, and a DOE light beam shaper. It is to be understood by those skilled in the art that the specific type and category of the light shaper 22 are only examples here, not limitations. For this reason, in other optional embodiments of the present invention, the light shaper 22 may also be implemented as other types of collimation lenses. It is to be noted that in the preferred embodiment of the present invention, the light shaper 22 is configured to guide the detection light in a specific direction, compress the divergence angle of the detection light and project the detection light shaped by the light shaper 22 to the light homogenizer 21.

As shown in the table below, for example, in the preferred embodiment of the present invention, the light shaper 22 employs an aspheric lens. The parameters of the light shaper are as follows:

| | Radius | | | | | | | |
|---|---|---|---|---|---|---|---|---|
| | of | Center | | | | Fourth | Sixth | Eighth |
| Surface | curvature | thickness | | Mechanical | Cone | order | order | order |
| type | (mm) | (mm) | Material | radius (mm) | coefficient | term | term | term |
| Even | 1.10836 | 1.8 | D-ZF10 | 1.69 | −1.099 | −1.3626E−002 | −9.895E−003 | 3.154E−003 |
| aspherical | | | | | | | | |
| surface | | | | | | | | |
| Even | −4.67979 | — | — | 1.69 | −1.078 | 1.278E−002 | — | — |
| aspherical | | | | | | | | |
| surface | | | | | | | | |

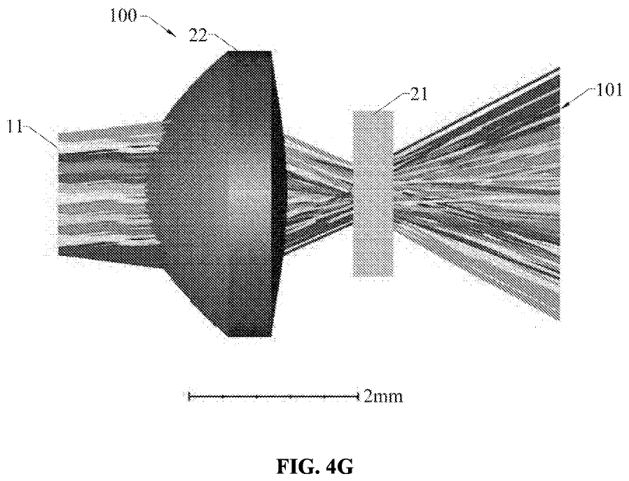

FIGS. 4A to 4F show optical path diagrams formed by the detection light transmitted by the light source units 11 in the first, third, fifth, seventh, ninth, and eleventh partitions of the illuminating light source 10. FIG. 4G shows the optical path diagram formed by the light source unit 11 of each partition of the illuminating light source 10 in a specific order at one detection period. It is to be understood by those skilled in the art that the detection light transmitted by the light source unit 11 of the illuminating light source 10 passes through the light shaper 22 and the light homogenizer 21 to form a rectangular target field of view interval 101 whose long side is in the horizontal direction. FIGS. 5A and 5B show a single target field of view interval 101 formed by one light source unit 11 of the illuminating light source 10 and the target field of view 110 formed by the combination of target field of view intervals 101 formed by multiple light source units 11. For example, the overall lighting area of 12 partitions is shown in FIG. 5B. The FOV of the ToF transmitting device is (30°˜150°)×(30°˜150°). Particularly, in the preferred embodiment of the present invention, the FOV of the ToF transmitting device 100 is 72°˜60°.

The light shaper 22 has a light incident surface 221 and a light emitting surface 222. The detection light transmitted by the illuminating light source 10 is incident to the light shaper 22 through the light incident surface 221. The light shaper 22 emits the shaped detection light to the light homogenizer 21 through the light emitting surface 222. The light shaper 22 is an aspheric lens (or a spherical lens). The light incident surface 221 of the light shaper 22 is an aspheric surface (or a spherical surface). The light emitting surface 222 of the light shaper 22 is a plane or a curved surface.

It is to be noted that in the preceding embodiment of the present invention, the light homogenizer 21 of the optical processing assembly 20 homogenizes the detection light transmitted by the illuminating light source 10 and projects the detection light outward to form the target field of view, and at the same time, the light homogenizing angle of the light homogenizer 21 is used for adjusting the lighting range of the detection light to form a continuous and uniform lighting area in the target field of view, thereby improving the detection accuracy and detection quality of the ToF depth information detector. In other words, the light homogenizer 21 can form a continuous and uniform lighting area in a specified target range. The light homogenizing angle of the light homogenizer 21 refers to an extension angle of the divergence angle of the detection light projected outward by the light homogenizer 21 compared to the divergence angle of the incident light lighting on the light homogenizer 21, that is, the range of lighting can be adjusted by the light homogenizing angle of the light homogenizer 21. In this manner, no gap exists between adjacent lighting areas.

Preferably, the light homogenizing unit 211 of the light homogenizer 21 can be configured to adjust the lighting range of the detection light transmitted by the corresponding light source unit 11 to form a continuous, uniform, and complete lighting area in the target field of view, thereby improving the detection accuracy and detection quality of the ToF depth information detector.

More preferably, the light homogenizing angle of a light homogenizing unit 211 of the light homogenizer 21 is equal to the difference between a first angle and a second angle. The first angle is the minimum lighting angle required for the detection light transmitted by adjacent light source units to generate no gap between adjacent lighting areas formed after the detection light is processed by the optical processing assembly 20. The second angle is a lighting angle formed after the detection light transmitted by a light source unit 11 is only shaped by the light shaper.

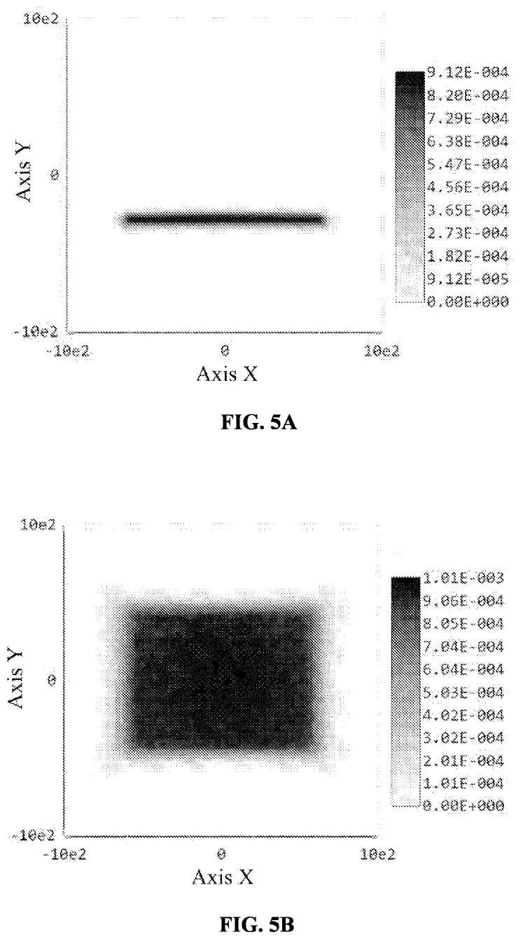

For example, FIG. 6A and FIG. 6B show diagrams of the light homogenizing angle of a light homogenizing unit 211 in the light homogenizer 21 of the optical processing assembly 20 in a first direction and the light homogenizing angle of the light homogenizing unit 211 in the light homogenizer 21 of the optical processing assembly 20 in a second direction respectively. θ_{H} denotes the light homogenizing angle of the light homogenizing unit of the light homogenizer in the first direction, and θ_{V} denotes the light homogenizing angle of the light homogenizing unit of the light homogenizer in the second direction. θ_{1H} denotes the first angle in the first direction, and θ_{1V} denotes the first angle in the second direction (that is, the divergence angle of the incident light lighting to the light homogenizer 21). θ_{2H} denotes the second angle in the first direction, and θ_{2V} denotes the second angle in the second direction (that is, the divergence angle of the detection light homogenized by the light homogenizer 21). For this reason, the relationship between the light homogenizing angle of the light homogenizing unit 211 of the light homogenizer 21 and the first angle and the second angle is as follows:

θ_{H}=θ_{1H}−θ_{2H}

θ_{V}=θ_{1V}−θ_{2V}

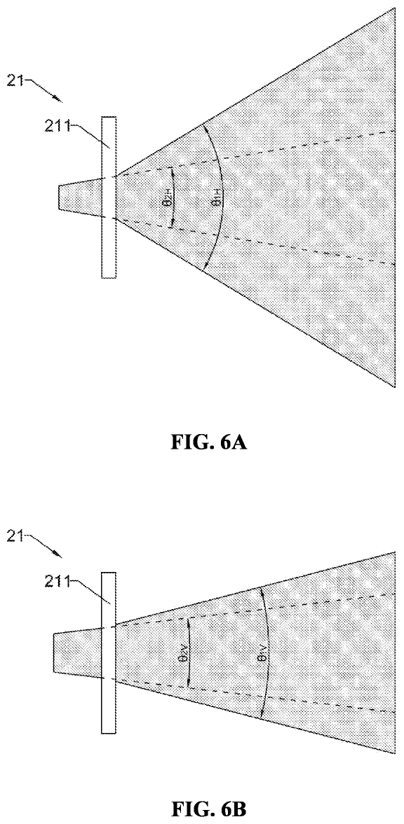

Still further, for example, FIG. 7A shows a distribution diagram of the light source units 11 of the illuminating light source 10. The illuminating light source 10 has Nₓ×N_{y} light source units 11 in total, that is, Nₓ denotes the number of light source units 11 of the illuminating light source 10 in the first direction (for example, the horizontal direction), and N_{y} denotes the number of light source units 11 of the illuminating light source 10 in the second direction (for example, the vertical direction); the size of each light source unit 11 in the first direction is W, and the size of each light source unit 11 in the second direction is H; and the spacing distance between adjacent light source units in the first direction is x, and the spacing distance between adjacent light source units in the second direction is y. Accordingly, FIG. 7A shows a distribution diagram of corresponding lighting areas in the target field of view. The total field of view angle of the target field of view in the first direction is FOV_{H}, and the total field of view angle of the target field of view in the second direction is FOV_{V}. The number of lighting areas in the first direction is Nₓ, and the number of lighting areas in the second direction is N_{y}.

It is to be noted that, to be able to ensure lighting uniformity in the target field of view and ensure that adjacent lighting areas in the target field of view are continuous without a gap, lighting in the entire target field of view is smooth and continuous. At the same time, to avoid the occurrence of a lighting blind area, reduce the probability of missed detection and misdetection, improve detection accuracy, increase a detection distance, reduce the sensitivity of an assembly and adjustment tolerance, and improve the robustness of the system, the light homogenizing angle of the light homogenizing unit 211 of the light homogenizer 21 of the optical processing assembly 20 of the present invention preferably satisfies the following relationship:

$${θ}_{H} \geq 2 * \{ arctan [ \frac{\vert {N}_{x} - 2 \times i \vert + 2}{{N}_{x}} \times tan ( {FOV}_{H} / 2 ) ] - arctan [ \frac{\vert {N}_{x} - 2 \times i \vert + 2 - x / ( W + x )}{{N}_{x}} \times tan ( {FOV}_{H} / 2 ) ] \}$$

$${θ}_{V} \geq 2 * \{ arctan [ \frac{\vert {N}_{y} - 2 \times j \vert + 2}{{N}_{y}} \times tan ( {FOV}_{V} / 2 ) ] - arctan [ \frac{\vert {N}_{y} - 2 \times j \vert + 2 - y / ( H + y )}{{N}_{y}} \times tan ( {FOV}_{V} / 2 ) ] \}$$

θ_{H} denotes the light homogenizing angle of each light homogenizing unit of the light homogenizer in the first direction, and θ_{V} denotes the light homogenizing angle of each light homogenizing unit of the light homogenizer in the second direction. Nₓ denotes the number of light source units of the illuminating light source in the first direction, and N_{y} denotes the number of light source units of the illuminating light source in the second direction. W denotes the size of a light source unit of the illuminating light source in the first direction, and H denotes the size of the light source unit of the illuminating light source in the second direction. x denotes the spacing distance between adjacent light source units in the first direction, and y denotes the spacing distance between adjacent light source units in the second direction. FOV_{H} denotes a total field of view angle in the first direction, and FOV_{V} denotes a total field of view angle in the second direction. i denotes the partition number of the light source unit in the first direction, and j denotes the partition number of the light source unit in the second direction.

It is to be understood that the light homogenizing angle of each homogenizing unit 211 of the light homogenizer 21 may be kept consistent (the same), or there may be differences. This is not repeated in the present invention.

More preferably, the focal length of the light shaper 22 of the optical processing assembly 20 may satisfy the following relationship:

$${f}_{x} = \frac{( W + x ) \times {N}_{x}}{2 \times tan ( {FOV}_{H} / 2 )}$$

$${f}_{y} = \frac{( H + y ) \times {N}_{y}}{2 \times tan ( {FOV}_{V} / 2 )}$$

Nₓ denotes the number of light source units of the illuminating light source in the first direction, and N_{y} denotes the number of light source units of the illuminating light source in the second direction. W denotes the size of the light source unit of the illuminating light source in the first direction, and H denotes the size of the light source unit of the illuminating light source in the second direction. x denotes the spacing distance between adjacent light source units in the first direction, and y denotes the spacing distance between adjacent light source units in the second direction. FOV_{H} denotes the total field of view angle in the first direction, and FOV_{V} denotes the total field of view angle in the second direction.

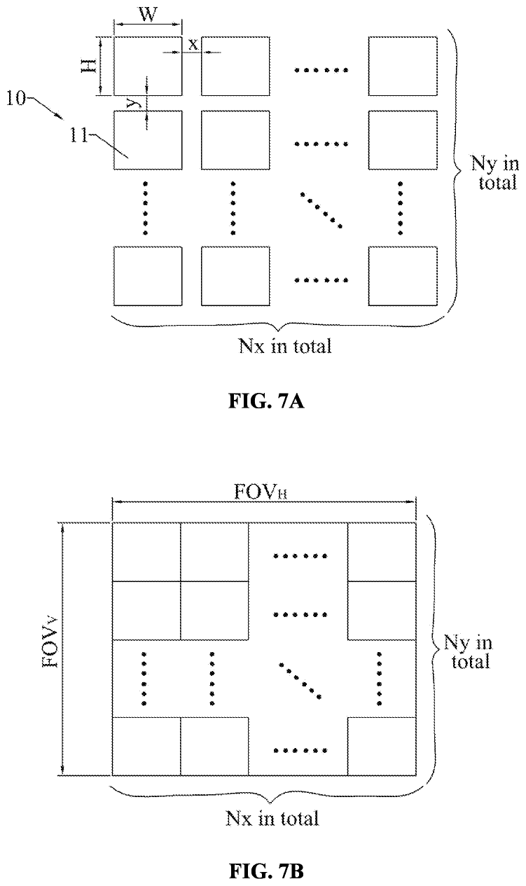

Referring to FIG. 8 of the drawings of the description of the present invention, another optional embodiment of the ToF transmitting device 100A according to the preceding preferred embodiment of the present invention is clarified in the following description. The ToF transmitting device 100A includes an illuminating light source 10A and an optical processing assembly 20A. The optical processing assembly 20A also includes a light homogenizer 21A and at least one light shaper 22A. The illuminating light source 10A is configured to transmit detection light in a predetermined timing in a partition transmitting manner. The ToF transmitting device 100A is configured to transmit the detection light to a target field of view 110A. The reflected light of the detected object in the target field of view 110A is received to obtain the depth detection information of the detected object.

Different from the preceding preferred embodiment, the light shaper 22A is disposed in the light incident direction of the light homogenizer 21A, that is, the light homogenizer 21A is disposed between the illuminating light source 10A and the light shaper 22A. In other words, in the preferred embodiment of the present invention, the light shaper 22A is implemented as a post-shaping element. The light shaper 22A narrows the divergence angle of the detection light of each partition of the illuminating light source 10A in the vertical direction through the light homogenizer 21A and guides the central propagation direction of the light beam of each partition of the light source 10A to the preset central angle of the partition.

The light homogenizer 21A has a light homogenizer incident surface 201A and a light homogenizer emitting surface 202A. The detection light transmitted by a light source unit 11A is incident to each light homogenizing unit 211A of the light homogenizer 21A through the light homogenizer incident surface 201A. The modulated detection light is emitted outward at a specific angle through the light homogenizer emitting surface 202A.

The light homogenizer 21A is disposed in the lighting direction of the illuminating light source 10A. The detection light transmitted by the illuminating light source 10A is projected to the light shaper 22A by the light homogenizer 21A. It is to be noted that in the preferred embodiment of the present invention, the structures and functions of the illuminating light source 10A, the light homogenizer 21A, and the light shaper 22A are the same as the structures and functions of the illuminating light source 10, the light homogenizer 21, and the light shaper 22 of the preceding first preferred embodiment. The difference is that the detection light transmitted by the illuminating light source 10A first passes through the light homogenizer 21A. The detection light transmitted by the illuminating light source 10A is homogenized by the light homogenizer 21A. The light homogenizer 21A emits the detection light to the light shaper 22A, whereby the light shaper 22 guides the light beam of each section of the illuminating light source 10A to a corresponding angle range.

The light shaper 22A has a light incident surface 221A and a light emitting surface 222A. The detection light transmitted by the illuminating light source 10A reaches the light incident surface 221A of the light shaper 22A through the light homogenizer 21A. The light shaper 22A emits the shaped detection light outward through the light emitting surface 222A. The light shaper 22A is an aspheric lens (or a spherical lens). The light incident surface 221A of the light shaper 22A is an aspheric surface (or a spherical surface). The light emitting surface 222A of the light shaper 22A is a plane or a curved surface structure. Preferably, in the preferred embodiment of the present invention, the light shaper 22A is implemented as a collimation lens or a group of collimation lenses.

It is to be noted that in the preferred embodiment of the present invention, the light shaper 22A may be, but is not limited to, a spherical lens, an aspheric lens, a Fresnel lens, and a DOE light beam shaper.

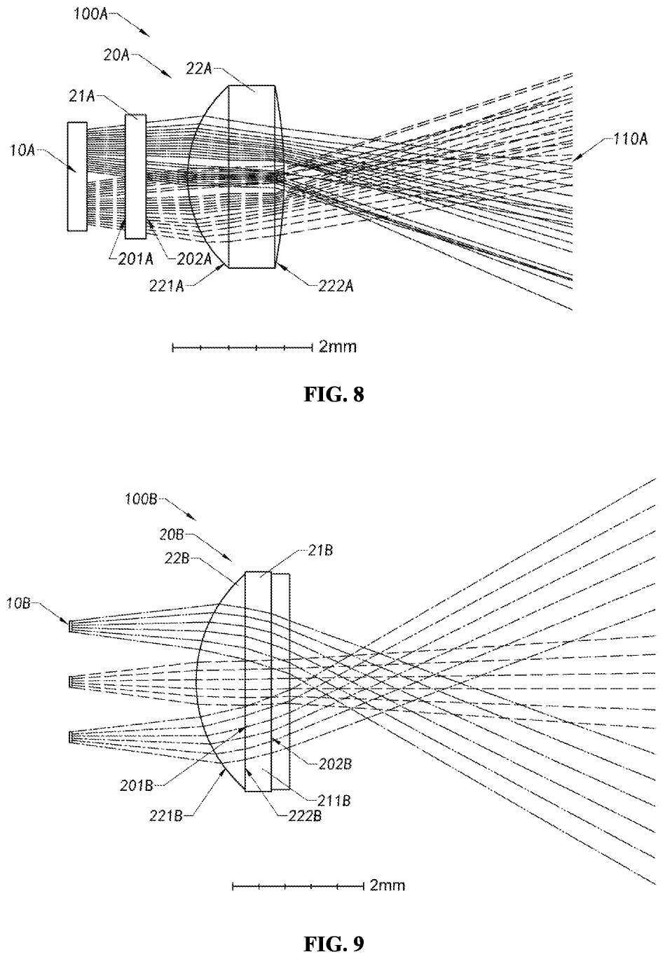

Referring to FIG. 9 of the drawings of the description of the present invention, another optional embodiment of an optical processing assembly 20B of the ToF transmitting device 100 according to the preceding preferred embodiment of the present invention is clarified in the following description. The optical processing assembly 20B includes a light homogenizer 21B and at least one light shaper 22B disposed on the light homogenizer 21B. The light homogenizer 21B and the light shaper 22B of the optical processing assembly 20B are made into an integrated structure. The light homogenizer 21B is disposed in the lighting direction of the illuminating light source 10B. The light homogenizer 21B is configured to homogenize the detection light transmitted by the illuminating light source 10 in a preset angle range and project the detection light outward to form a target field of view. The light shaper 22B of the optical processing assembly 20B is located in the light incident direction of the light homogenizer 21B. The light shaper 22B is configured to narrow the divergence angle of the detection light transmitted by each partition of the illuminating light source 10B. It is to be understood that in the preferred embodiment of the present invention, the light shaper 22B is implemented as a pre-shaping element. The light shaper 22B is disposed in the light incident direction of the light homogenizer 21B, whereby the light shaper 22B narrows the divergence angle of the detection light transmitted by each partition of the illuminating light source 10B in the vertical direction and guides the central propagation direction of the light beam of each partition of the light source 10B to the preset central angle of the partition.

Preferably, in the preferred embodiment of the present invention, the light homogenizer 21B of the optical processing assembly 20B is disposed on the light emitting surface 222B of the light shaper 22B by means of imprinting. Corresponding to the partition of the light transmitting source 10B, the light homogenizer 21B also has a corresponding partition structure. Each partition structure of the light homogenizer 21B has a different design and microstructure. The partition structure of the light homogenizer 21B modulates the light beam transmitted by each light source unit 11B of the light transmitting source 10B and homogenizes the light beam transmitted by the light source unit 11 in a specified range.

It is to be understood by those skilled in the art that the structure of the light homogenizer 21B is only an example here, not a limitation. For this reason, in other optional embodiments of the present invention, the light homogenizer 21B may be implemented as a non-partitioned structure, that is, the light homogenizer 21B is an integrated structure.

The light homogenizer 21B includes multiple light homogenizing units 211B. Each light homogenizing unit 211B corresponds to the light source unit 11B of the illuminating light source 10B. A light homogenizing unit 211B modulates the detection light transmitted by at least one light source unit 11B of the illuminating light source 10B. Each light homogenizing unit 211B homogenizes the detection light transmitted by the light source unit 11B in a specific range. Preferably, in the preferred embodiment of the present invention, the number of light source units 11B of the illuminating light source 10B is the same as the number of light homogenizing units 211B of the light homogenizer 21B. Each light homogenizing unit 211B faces the light projection direction of a light source unit 11B. It is to be understood by those skilled in the art that the number of partitions of the light homogenizing units 211B of the light homogenizer 21B is different from the number of light source units 11B. For example, two light source units 11B correspond to the same light homogenizing unit 211B.

The light homogenizer 21B has a light homogenizer incident surface 201B and a light homogenizer emitting surface 202B. The detection light transmitted by a light source unit 11B is incident to each light homogenizing unit 211B of the light homogenizer 21B through the light homogenizer incident surface 201B. The modulated detection light is emitted outward at a specific angle through the light homogenizer emitting surface 202B. It is to be noted that in the preferred embodiment of the present invention, the structure and function of the light homogenizer 21B are the same as the structure and function in the preceding first preferred embodiment.

It is to be noted that in the preferred embodiment of the present invention, the light homogenizer 21B and the light shaper 22B are an integrated structure, so that the total length of the system of the ToF transmitting device 100B can be reduced, the volume of the depth information detector is reduced, and the difficulty of assembly and adjustment is reduced. The light shaper 22B is an aspheric lens (or a spherical lens). The light incident surface 221B of the light shaper 22B is an aspheric surface (or a spherical surface). The light emitting surface 222B of the light shaper 22B is a plane or a curved surface structure.

It is to be understood by those skilled in the art that the light homogenizer 21B of the optical processing assembly 20B is disposed on the light emitting surface 222B of the light shaper 22B, that is, the light homogenizer 21B and the light shaper 22B are fixed in alignment to prevent relative displacement of the light homogenizer 21B and the light shaper 22B during use. For this reason, the stability of the ToF transmitting device 100B in operation can be further improved.

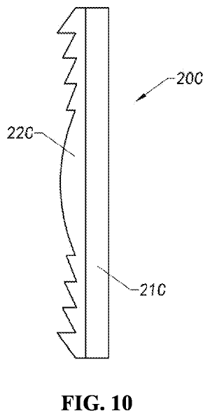

Referring to FIG. 10 of the drawings of the description of the present invention, another optional embodiment of an optical processing assembly 20C of the ToF transmitting device 100 according to the preceding preferred embodiment of the present invention is clarified in the following description. The optical processing assembly 20C includes a light homogenizer 21C and at least one light shaper 22C disposed on the light homogenizer 21C. The illuminating light source 10C is configured to transmit detection light in a predetermined timing in a partition transmitting manner. Different from the preceding preferred embodiment, the light shaper 22C of the ToF transmitting device 100C is implemented as a Fresnel pre-shaper or a DOE pre-shaper. It is to be understood by those skilled in the art that the light homogenizer 21C is disposed on the light shaper 22C. Since the light shaper 22C is a Fresnel pre-shaper or a DOE pre-shaper, the ToF transmitting device 100C can further reduce the volume. It is to be noted that the light homogenizer 21C and the light shaper 22C of the ToF transmitting device 100C can be manufactured by double-sided imprinting, thereby saving the manufacturing cost, reducing the manufacturing difficulty, and improving the product yield.

Preferably, in the preferred embodiment of the present invention, the ToF depth information detector is implemented as a ToF camera module, that is, the ToF transmitting device 100 is the transmitting terminal of the ToF camera module, and the receiving device 200 is the receiving terminal of the ToF camera module. It is to be understood that in the preferred embodiment of the present invention, the embodiment of a ToF depth information detection device is only an example here, not a limitation.

It is to be understood by those skilled in the art that the embodiments of the present invention described in the above description and drawings are by way of example only and not intended to limit the present invention. The purpose of the present invention is implemented completely and efficiently. The function and structural principle of the present invention are shown and illustrated in the embodiments, and the embodiments of the present invention may be altered or modified without departing from the principle.

1. An optical processing assembly applied to an illuminating light source, wherein the illuminating light source is configured to transmit detection light to a target field of view, wherein the illuminating light source comprises a plurality of light source units, and each light source unit of the plurality of light source units is lit according to a predetermined timing; and the optical processing assembly comprises:
at least one light shaper, wherein the at least one optical shaper is configured to perform light beam shaping on detection light transmitted by the each light source unit of the illuminating light source to narrow a divergence angle of the detection light and guide a central propagation direction of the each detection light to a preset central angle of a partition; and
a light homogenizer, wherein the light homogenizer is configured to homogenize the detection light transmitted by the each light source unit and project the detection light outward to form a target field of view interval, and a light homogenizing angle of the light homogenizer is used for adjusting a lighting range of the detection light to form a continuous and uniform lighting area in the target field of view.

2. The optical processing assembly according to claim 1, wherein the light homogenizer comprises a plurality of light homogenizing units, and each light homogenizing unit of the plurality of light homogenizing units is configured to homogenize detection light transmitted by a corresponding light source unit of the plurality of light source units; or the light homogenizer comprises a whole sheet of light homogenizing sheet configured to homogenize all detection light transmitted by the illuminating light source.

3. The optical processing assembly according to claim 2, wherein a light homogenizing angle of the each light homogenizing unit of the light homogenizer is equal to a difference between a first angle and a second angle, wherein the first angle is a minimum lighting angle required for detection light transmitted by adjacent light source units of the plurality of light source units to generate no gap between adjacent lighting areas formed after the detection light is processed by the optical processing assembly; and the second angle is a lighting angle formed after detection light transmitted by a light source unit of the plurality of light source units is only shaped by the light shaper.

4. The optical processing assembly according to claim 3, wherein the light homogenizing angle of the each light homogenizing unit of the light homogenizer satisfies the following relationship:
$${θ}_{H} \geq 2 * \{ arctan [ \frac{\vert {N}_{x} - 2 \times i \vert + 2}{{N}_{x}} \times tan ( {FOV}_{H} / 2 ) ] - arctan [ \frac{\vert {N}_{x} - 2 \times i \vert + 2 - x / ( W + x )}{{N}_{x}} \times tan ( {FOV}_{H} / 2 ) ] \}$$
$${θ}_{V} \geq 2 * \{ arctan [ \frac{\vert {N}_{y} - 2 \times j \vert + 2}{{N}_{y}} \times tan ( {FOV}_{V} / 2 ) ] - arctan [ \frac{\vert {N}_{y} - 2 \times j \vert + 2 - y / ( H + y )}{{N}_{y}} \times tan ( {FOV}_{V} / 2 ) ] \}$$
wherein θ_{H} denotes a light homogenizing angle of the each light homogenizing unit of the light homogenizer in a first direction, and θ_{V} denotes a light homogenizing angle of the each light homogenizing unit of the light homogenizer in a second direction; Nₓ denotes a number of light source units of the plurality of light source units of the illuminating light source in the first direction, and N_{y} denotes a number of light source units of the plurality of light source units of the illuminating light source in the second direction; W denotes a size of a light source unit of the plurality of light source units of the illuminating light source in the first direction, and H denotes a size of the light source unit of the illuminating light source in the second direction; x denotes a spacing distance between adjacent light source units in the first direction, and y denotes a spacing distance between adjacent light source units in the second direction; FOV_{H} denotes a total field of view angle in the first direction, and FOV_{V} denotes a total field of view angle in the second direction; and i denotes a partition number of the light source unit in the first direction, and j denotes a partition number of the light source unit in the second direction.

5. The optical processing assembly according to claim 1, wherein a focal length of the light shaper satisfies the following relationship:
$${f}_{x} = \frac{( W + x ) \times {N}_{x}}{2 \times tan ( {FOV}_{H} / 2 )}$$
$${f}_{y} = \frac{( H + y ) \times {N}_{y}}{2 \times tan ( {FOV}_{V} / 2 )}$$
wherein Nₓ denotes a number of light source units of the plurality of light source units of the illuminating light source in a first direction, and N_{y} denotes a number of light source units of the plurality of light source units of the illuminating light source in a second direction; W denotes a size of a light source unit of the plurality of light source units of the illuminating light source in the first direction, and H denotes a size of the light source unit of the illuminating light source in the second direction; x denotes a spacing distance between adjacent light source units of the plurality light source units in the first direction, and y denotes a spacing distance between adjacent light source units of the plurality light source units in the second direction; and FOV_{H} denotes a total field of view angle in the first direction, and FOV_{V} denotes a total field of view angle in the second direction.

6. (canceled)

7. The optical processing assembly according to claim 1, wherein the light shaper is adapted to be disposed between the light homogenizer and the illuminating light source and configured to project the detection light transmitted by the illuminating light source to the light homogenizer after the detection light is pre-shaped by the light shaper.

8. The optical processing assembly according to claim 1, wherein the light homogenizer is adapted to be disposed between the illuminating light source and the light shaper and configured to project the detection light transmitted by the illuminating light source to the light shaper after the detection light is homogenized by the light homogenizer.

9. The optical processing assembly according to claim 1, wherein the light shaper and the light homogenizer are two separate components or form an integral component.

10. The optical processing assembly according to claim 2, wherein the light shaper has a light incident surface and a light emitting surface, wherein each light homogenizing unit of the light homogenizer is disposed on the light incident surface of the light shaper.

11. The optical processing assembly according to claim 10, wherein the plurality of light homogenizing units of the light homogenizer are disposed on the light incident surface of the light shaper by imprinting.

12. The optical processing assembly according to claim 1, wherein the light homogenizer is a light homogenizing sheet based on light refraction.

13. A ToF transmitting device, the device being configured to transmit detection light to a target field of view and comprising:
an illuminating light source configured to periodically transmit the detection light in a partition transmitting manner in a certain order to light up the target field of view; and
an optical processing assembly comprising:
at least one light shaper disposed in a lighting direction of the illuminating light source and configured to perform light beam shaping on the detection light transmitted by the illuminating light source to narrow a divergence angle of the detection light and guide a central propagation direction of the detection light to a preset central angle of a partition; and
a light homogenizer disposed in the lighting direction of the illuminating light source and configured to homogenize the detection light transmitted by the illuminating light source and project the detection light outward to form a target field of view interval, wherein a light homogenizing angle of the light homogenizer is used for adjusting a lighting range of the detection light to form a continuous and uniform lighting area in the target field of view.

14. The ToF transmitting device according to claim 13, wherein the illuminating light source comprises a plurality of light source units, and each of the plurality of light source units is lit according to a predetermined timing, so that the detection light transmitted by the plurality of light source units is projected outward by the light homogenizer to form the target field of view.

15. The ToF transmitting device according to claim 14, wherein the light homogenizer comprises a plurality of light homogenizing units, and each of the plurality of light homogenizing units is configured to correspondingly homogenize detection light transmitted by a light source unit of the plurality of light source units; or the light homogenizer comprises a whole sheet of light homogenizing sheet configured to homogenize all detection light transmitted by the illuminating light source.

16. (canceled)

17. An optical processing method, comprising the steps:
performing, by at least one light shaper, light beam shaping on detection light transmitted by each light source unit of an illuminating light source to narrow a divergence angle of the detection light and guiding, a central propagation direction of the each detection light to a preset central angle of a partition; and
homogenizing, by a light homogenizer, the detection light transmitted by the each light source unit and adjusting, a lighting range of the detection light to form a continuous and uniform lighting interval in a target field of view.

18. The optical processing method according to claim 17, wherein the each light source unit of the illuminating light source is lit according to a predetermined timing, so that each light source unit transmits the detection light according to the predetermined timing, and a target field of view interval formed by the processed detection light is combined to form the target field of view.

19. The optical processing method according to claim 17, wherein the light homogenizer performs light homogenizing based on refraction of light by a microstructure of a surface of the light homogenizer and adjusts a light homogenizing angle, space of a light field, and energy distribution of the light field by changing a shape and arrangement of the microstructure.

20. The optical processing method according to claim 19, wherein the light shaper is disposed in a light incident direction of the light homogenizer so that light field pre-shaping is performed, by the light shaper, on the detection light projected by the illuminating light source to the light homogenizer.

21. The optical processing method according to claim 19, wherein the light shaper is disposed in a light emitting direction of the light homogenizer so that a light beam of each partition of the illuminating light source homogenized by the light homogenizer is guided to a corresponding angle range by the light shaper.

22. The optical processing method according to claim 17, wherein the light homogenizer comprises a plurality of light homogenizing units, and each light homogenizing unit of the plurality of light homogenizing units is configured to homogenize detection light transmitted by a corresponding light source unit of the plurality of light source units; and a light homogenizing angle of the each light homogenizing unit of the light homogenizer satisfies the following relationship:
$${θ}_{H} \geq 2 * \{ arctan [ \frac{\vert {N}_{x} - 2 \times i \vert + 2}{{N}_{x}} \times tan ( {FOV}_{H} / 2 ) ] - arctan [ \frac{\vert {N}_{x} - 2 \times i \vert + 2 - x / ( W + x )}{{N}_{x}} \times tan ( {FOV}_{H} / 2 ) ] \}$$
$${θ}_{V} \geq 2 * \{ arctan [ \frac{\vert {N}_{y} - 2 \times j \vert + 2}{{N}_{y}} \times tan ( {FOV}_{V} / 2 ) ] - arctan [ \frac{\vert {N}_{y} - 2 \times j \vert + 2 - y / ( H + y )}{{N}_{y}} \times tan ( {FOV}_{V} / 2 ) ] \}$$
wherein θ_{H} denotes a light homogenizing angle of the each light homogenizing unit of the light homogenizer in a first direction, and θ_{V} denotes a light homogenizing angle of the each light homogenizing unit of the light homogenizer in a second direction; Nₓ denotes a number of light source units of the plurality of light source units of the illuminating light source in the first direction, and N_{y} denotes a number of light source units of the plurality of light source units of the illuminating light source in the second direction; W denotes a size of a light source unit of the plurality of light source units of the illuminating light source in the first direction, and H denotes a size of the light source unit of the illuminating light source in the second direction; x denotes a spacing distance between adjacent light source units of the plurality light source units in the first direction, and y denotes a spacing distance between adjacent light source units of the plurality light source units in the second direction; FOV_{H} denotes a total field of view angle in the first direction, and FOV_{V} denotes a total field of view angle in the second direction; and i denotes a partition number of the light source unit in the first direction, and j denotes a partition number of the light source unit in the second direction.

23-27. (canceled)
